(19) United States
(12) Patent Application Publication
(10) Pub. No.: US 2013/0060670 A1
(43) Pub. Date: Mar. 7, 2013

(54) ALERT BASED PERSONAL FINANCE MANAGEMENT SYSTEM

(71) Applicants: David Galloway, North Vancouver (CA); Donald MacCormick, London (GB); Peter Madams, Benicia, CA (US)

(72) Inventors: David Galloway, North Vancouver (CA); Donald MacCormick, London (GB); Peter Madams, Benicia, CA (US)

(73) Assignee: ClairMail, Inc., San Rafael, CA (US)

(21) Appl. No.: 13/405,159

(22) Filed: Feb. 24, 2012

Related U.S. Application Data
(60) Provisional application No. 61/446,968, filed on Feb. 25, 2011.

(51) Int. Cl. G06Q 40/00

(52) U.S. Cl. 705/35

(57) ABSTRACT

Techniques for credential free, alert based personal finance management are disclosed herein. An embodiment of a credential free, alert based method comprises receiving from a financial institution a transaction message indicating a transaction that occurs a short time period ago; recognizing the transaction message and translating the transaction message into an alert in a predetermined uniform format; transmitting the alert to a user's device and prompting a user to tag the transaction with at least one category; and receiving from the user's device a response indicating the category that the user tagged.

### RELATED APPLICATIONS

This application claims the benefit of U.S. provisional application No. 61/446,968, filed on Feb. 25, 2011, which is incorporated herein by reference.

### FIELD OF THE INVENTION

At least one embodiment of the present invention pertains to a credential free, alert based personal finance management system.

### BACKGROUND

Money management software such as Quicken, Microsoft Money, and GnuCash are available for expense tracking and financial budget planning. These programs require the user to categorize past personal or household expenses and then display monthly or quarterly reports for future budget planning. A user of such software typically downloads all transaction statements from the financial institutions every month, either within the software, or on the websites of the financial institutions. Then the user reviews and categorizes all the transactions so that the software can generate and present the financial report summarizing the past expenses in each category. However, during the process, the user spends a large amount of time each month reviewing all the transactions and trying to recall each transaction, some of which may have occurred days or weeks ago.

During recent years, web-based personal financial management services such as Mint.com or Yodlee Moneycenter, have started to emerge. These web-based services allow users to track bank, credit card, investment, and loan transactions and balances from multiple financial institutions through a single user online interface. However, users of the web-based services still need to spend time recalling the past transactions to instruct the service to properly categorize the transactions.

It is desirable to relieve the users' burden of memorizing and recalling all of the detailed information about their financial transactions and to efficiently track and categorize the transactions.

### SUMMARY

The technology introduced here includes a Credential Free, Alert Based (CFAB) personal finance management system. The system uses instant or near real-time alerts such as short message service (“SMS”) messages to help track personal financial expenses and transactions. After a user incurs an expense or a financial transaction, an alert is sent to a device associated with the user, such as mobile phone, instantly or in a short time period. The alert triggers the device to present a user-friendly interface to allow the user to categorize the expense or transaction immediately. The inputs from the user are transferred back to and stored in a database running on one or more servers. Since the expense or transaction happens immediately before the alert, the user spends much less time trying to recall the nature of the expense or transaction, compared to conventional expense tracking methods.

Unlike other applications that endeavor to consolidate financial information for users, the User is not required to provide any confidential information to the system or any other parties in order for the system to work.

In one embodiment, a CFAB method for personal finance management comprises receiving from a financial institution a transaction message indicating a transaction that occurred a short time period ago; recognizing the transaction message and translating the transaction message into an alert in a predetermined format; transmitting the alert to a user's device and prompting a user to tag the transaction with at least one category; and receiving from the user's device a response indicating the category that the user tagged.

Other aspects of the technology introduced here will be apparent from the accompanying figures and from the detailed description which follows.

### BRIEF DESCRIPTION OF THE DRAWINGS

These and other objects, features and characteristics of the present invention will become more apparent to those skilled in the art from a study of the following detailed description in conjunction with the appended claims and drawings, all of which form a part of this specification. In the drawings:

FIG. 1 is a block diagram of a personal finance management system interacting with a user's mobile device;

FIG. 2 illustrates an example of a process of categorizing financial transactions; and

FIG. 3 is a block diagram of a processing system that can be used to implement the techniques described herein.

### DETAILED DESCRIPTION

References in this specification to “an embodiment,” “one embodiment,” or the like, mean that the particular feature, structure, or characteristic being described is included in at least one embodiment of the present invention. Occurrences of such phrases in this specification do not necessarily all refer to the same embodiment.

In one embodiment, a financial institution, such as a bank or a credit card company, receives a request for an expense or transaction. Once the financial institution has processed the expense or transaction, typically in minutes nowadays, the financial institution sends a message to a user-provided contact address to inform the user of the expense or transaction. For example, the user-provided contact address may be an email address. The message to the email address will be processed by the CFAB system and all related information in the message is recognized by the CFAB system. Then the CFAB system translates the message into an alert in a CFAB predetermined uniform format and transmits the alert to the user's mobile phone or other device associated with the user, by using a phone number or other address or identifier of the user's device previously provided by the user to the CFAB system. The mobile phone presents the alert to the user with a user interface on the device. The user inputs via the interface to categorize the transaction. For example, when the user sees a $40 expense in Mobil, which may occur two minutes ago, the user selects category “gasoline” from a list of recommended categories and clicks “OK”. The response is sent to a database in the CFAB system via the network. The database keeps track of the categorizing (also referred to as tagging) of the expenses and transactions and is able to generate a financial report on different categories for a certain time period.

The CFAB system does not need to have any credentials from the user to access any accounts of the financial institutions. The user only needs to inform the financial institutions or setup in the account an email address that the CFAB system can access.

In one embodiment, the CFAB system may be set up as a standalone service not affiliated with any financial institutions. In another embodiment, the CFAB system may be set up as an add-on service in addition to existing services for customers of a financial institution. Therefore customers consolidate all their financial information through the financial institution's service and customer loyalty is promoted.

In one embodiment, the predetermined uniform format for the alert may include a time stamp, an amount, a merchant ID and other information that helps the user to categorize the expense or transaction.

In one embodiment, the CFAB system records all the categorizing information in the database. If the CFAB system recognizes repeated patterns about how the user decides on a particular type of transaction, the CFAB system may learn from the pattern and automatically list the predicted category as the default category for the user to choose.

The process of the CFAB system is driven by messages and alerts. There is no confidential information required for the CFAB system to operate. Just like ATM receipts, only background information for the transaction will be accessed and processed by the CFAB system. Therefore, the CFAB system will not leak any confidential information. The user is NOT required to provide any confidential financial account(s) information to other institutions to allow CFAB to work.

The CFAB system may work as a stand-alone service direct to the consumer, independent of any financial institutions. Or the CFAB system may be setup as an add-on service from a financial institution.

By setup multiple financial accounts from different financial institutions to send transaction message to an email address within the CFAB system, user can aggregate multiple accounts across multiple financial institutions. The CFAB system is highly secure because there is no confidential account information exchanged in the messages or alerts.

The user of the CFAB system potentially saves a large amount of time since it may only take seconds to recall the transaction and categorize it using the instant feedback alert from CFAB system, instead of recalling all the nature of a batch of transactions happened days and/or weeks ago. In this way, the user is able to categorize transactions one at a time, and each transaction only take the user a few seconds since the transaction just occurred a short time period ago. The short time period within this disclosure means a time period within which an average person still can recall the nature of the transaction effortless, typically from at most a few minutes or hours, as opposed to days or weeks. In contrast, a user of conventional methods may spend a large amount of time each month reviewing all the transactions and trying to recall each transaction, some of which may have occurred days or weeks ago

Customers can enroll in the CFAB system via SMS, web browser, computer application, emails or other communication methods. In one embodiment, the system provides each enrolled customer a unique email address to send all alerts to. The unique email address may be referred to Customer Master Address (“CMA”). In one embodiment, the CMA is associated with the customer's phone number to allow the system to send SMS alert to customer's mobile phone. The consumer contacts the financial institutions to instruct the financial institutions to send transaction message to the CMA email address. The consumer may log on the online account of a financial institution to do so. Therefore, all transaction messages will be sent to the CMA email address within the CFAB system. The CFAB system will recognize the information from the messages through an intelligent alert process and send the alerts to consumer's mobile phone. The consumer can also manually forward messages to the CMA email address for the CFAB system to process. In another embodiment, the alert may be sent to an application running the customer's mobile device. In yet another embodiment, the alert may be sent as an email.

In one embodiment, the consumer can set an automatic process transaction level. All transactions having an amount below certain number will be automatically assigned to a category by default, such as a miscellaneous or small amount category. The CFAB system comes with pre-defined category for consumer to choose. The consumers can also define their own categories. The alerts may be for all transactions on the account, such as checks, deposits, debit memos, debit card transactions, credit card transactions. By entering multiple recipients, the CFAB system allows multiple people to do the categorizing. For example, there may be a joint account. An alert for a transaction in the joint account may be sent to the mobile phones of both husband and wife. The husband may respond with the categorizing decision. The CFAB system records the decision and the wife may also be notified about the categorizing decision.

In one embodiment, the predetermined uniform format of the alert may contains a data model for multiple types of information. The data model may include the CMA email address and the administrator, whether business or personal, list of family members, list of default categories, merchant ID and merchant type. The data model may further include a time stamp including day, month and year, transaction amount, source entity for the alert such as banks, credit unions, credit card companies, type of alert such as withdrawal, overdraft or expense, count that the alert is for, data/time of the transaction, and date/time/person that categorized the transaction.

In one embodiment, upon receiving the account sign up request, the CFAB system creates a CFAB user account for the consumer. The system requires the user to confirm its target address such as the mobile phone number. For example, once the user provides the phone number, a confirmation alert is sent to the phone number. If the user provides the valid legitimate phone number, he/she will be able to receive and respond the confirmation alert by methods such as providing a PIN.

In one embodiment, the first alert from any source entity needs to be confirmed by the user. During the initial setup, the system also accepts the user's threshold amount to filter small transactions into miscellaneous category. The system is configured to automatically send alerts based on the threshold and source address to the user. The system sets up default groupings and categories. For example, the system may set up business and personal groups. Each of the business and personal groups may contain 10 to 15 most common categories. Each alert type has to be recognized by the system. For example, the messages may be properly parsed by the intelligent parsing algorithm.

In one embodiment, the alert arrives at user's mobile device in near real time after the transaction at the merchant. The actual time period between the transaction and alert may depend on specifics of implementation. Near real time alert makes it easier for the user to know what the alert item is about. The alert may show the merchant, date, time and amount to help the user to identify the transaction. The alert may utilize existing standard data formats for financial transactions, as ordinary skilled person in the art can appreciate.

The system may monitor the state model of whether the user has responded to the alert yet. The state model of an alert can be pending, means that the user has not responded to the alert yet. Or the state model can be processed, meaning that the user has already categorized the transaction and responded to the alert. Each alert and its corresponding response can be identified by a transaction ID. The user can send a command to the system requesting a list of all pending transactions, or a command to the system requesting a list of all processed transactions.

The user may issue a hold command to request the system to hold all alerts. For example, a user may be traveling out of the country and he does not want to incur roaming charges from the alerts. So the system will hold all the alerts until the user issues an unhold command. Once an unhold command is received, the system may send out the held alerts every half minute until all alert are sent so that the user can work on the categorizing the transactions in a paced manner.

In one embodiment, once an alert arrives, the user is prompted with questions to help the user to categorize the transaction. For example, the system may ask the user whether is a personal or business transaction, ask the user to select the person did the transaction, and select the proper category. In one embodiment, the system will automatically generate short cuts for all data entry, one key for each data entry. Entries such as personal/business or who conducted the transaction may be automatically filled in as default. The system may automatically remember the last grouping for that merchant so the next item form the merchant may have personal/business filled in as default automatically. The system analyzes the response pattern from the user and may automatically set the entries if the transaction fits certain pattern learnt from past transactions. Therefore after training using past responses, the system may categorize most of regular transaction by itself, and the user receives alerts only in occasions of irregular transactions.

In one embodiment, the system may allow the user to issue a command asking for a summary month to date report for all categories. The system may allow the user to issue a command asking for a summary month to date report for a particular category. In addition, the system allows users to define their own short cut commands so that users can use less keystrokes to assign frequently used category.

In one embodiment, the system stores the data in groups so the data is easy to retrieve. The data may be automatically grouping by user, by whether it's personal or business, by category, or by time stamps. The user may retrieve a summary report for month to date, last month, quarter to date, last quarter or year to date. The user may export details and summaries in a standard file format, such as excel, comma separated file, or Quicken format. The file may be transmitted to an email registered in the account.

In one embodiment, users may assign a wrong category to a transaction. The system may allow the user to issue a correction command to make correction for the last response. A user may manually add a transaction and its category into the system, such as a cash transaction. A user may manually add a transaction for different financial institutions, other accounts, or other person conducting the transactions.

In one embodiment, the commands are received by the system as SMS messages transmitted from the user's mobile phone. In another embodiment, the commands may be generated by an application on the mobile phone, based on the user inputs on the application interface. After that, the command is transmitted to the server via a network protocol.

In one embodiment, the system uses intelligent message recognition to parse the incoming messages from the financial institutions. The system may access and monitor an inbound email address for any incoming messages from the financial institutions. In one embodiment, the inbound email address may be an internal email address within the system, such as the CMA disclosed in previous paragraphs. In another embodiment, the monitored email address may be a third-party email address that the user provide login information for the system to access and monitor the emails. The inbound email address is used as a source address for alerts from any source entities such as financial institutions. The system parses the inbound emails and translates it into an alert to be sent to the user for tagging or categorizing. The intelligent message recognition algorithm is used to maps data elements in inbound emails to data elements in predetermined uniform outbound alerts. The recognition processing of the inbound emails is refined through the continuous feeds of transaction messages. The system may automatically tag the source entity for the alert, since the system knows what the source is and account for the inbound message.

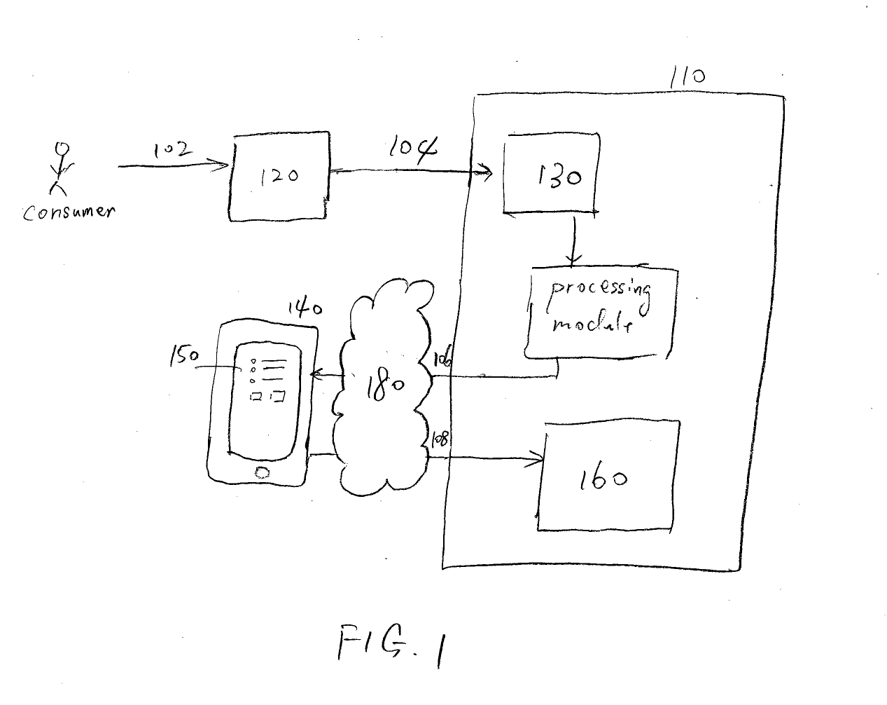

FIG. 1 illustrates a credential free, alert based personal finance management system 110. A financial institution 120, such as a bank or a credit card company, receives the request 102 for the expense or transaction. Once the financial institution 120 has processed the expense or transaction, the financial institution 120 sends a message 104 to a user-provided contact 130 of system 110 to inform the expense or transaction. For example, the user-provided contact may be an email address. The message to the email address is processed by the CFAB system 110 and all related information in the message is recognized by the CFAB system 110. Then the CFAB system 110 translates the message 104 into an alert 106 in a predetermined uniform format and transmits the alert 106 to the user's mobile device 140, such as a mobile phone. The mobile phone 140 presents the alert to the user with an interface 150. The user inputs via the interface 150 to categorize the transaction. The response 108 is sent to a database 160 in the CFAB system 110 via the network 180. The network 180 may be a mobile phone network, a short message service (“SMS”) network, Local Area Network (LAN), Wide Area Network (WAN), or the Internet. The database 160 keeps track of the categorizing (also referred to as tagging) of the expenses and transactions and is able to generate a financial report on different categories for a certain time period.

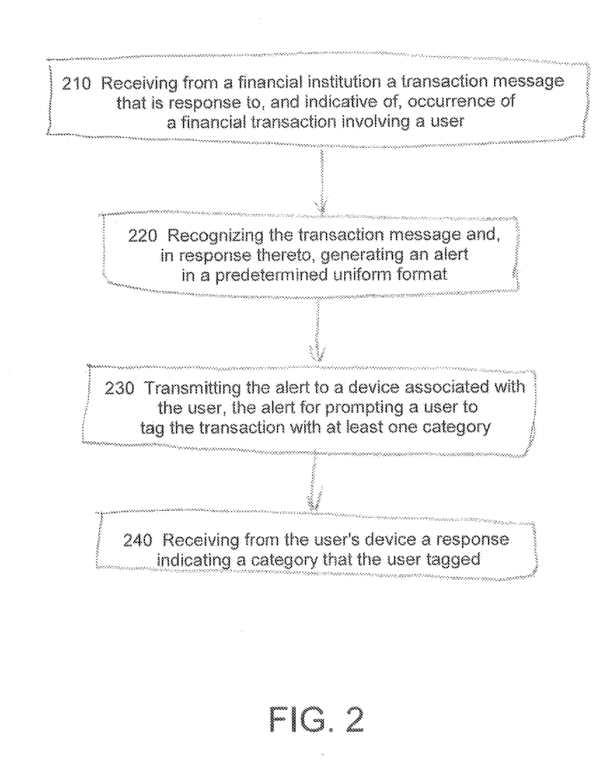

A sample process of categorizing financial transactions is illustrated in FIG. 2. The credential free, alert based method for managing personal finance comprises: step 210, receiving from a financial institution a transaction message that is response to, and indicative of, occurrence of a financial transaction involving a user; step 220, recognizing the transaction message and, in response thereto, generating an alert in a predetermined uniform format; step 230, transmitting the alert to a device associated with the user, the alert for prompting a user to tag the transaction with at least one category; and step 240, receiving from the user's device a response indicating a category that the user tagged.

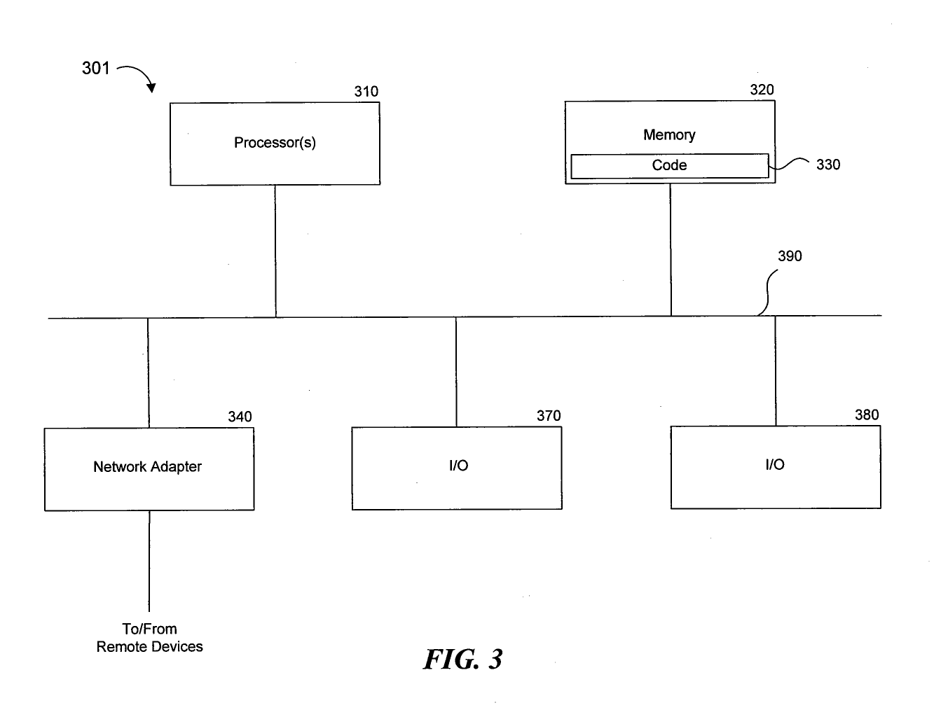

FIG. 3 is a block diagram of a processing system that can be used to implement any of the techniques described above, as CFAB personal finance management system. Note that in certain embodiments, at least some of the components illustrated in FIG. 3 may be distributed between two or more physically separate but connected computing platforms or boxes. The processing can represent a conventional server-class computer, PC, mobile communication device (e.g., smartphone), or any other known or conventional processing/communication device.

The processing system 301 shown in FIG. 3 includes one or more processors 310, i.e. a central processing unit (CPU), memory 320, at least one communication device 340 such as an Ethernet adapter and/or wireless communication subsystem (e.g., cellular, Wi-Fi, Bluetooth or the like), and one or more I/O devices 370, 380, all coupled to each other through an interconnect 390.

The processor(s) 310 control(s) the operation of the computer system 301 and may be or include one or more programmable general-purpose or special-purpose microprocessors, microcontrollers, application specific integrated circuits (ASICs), programmable logic devices (PLDs), or a combination of such devices. The interconnect 390 can include one or more buses, direct connections and/or other types of physical connections, and may include various bridges, controllers and/or adapters such as are well-known in the art. The interconnect 390 further may include a “system bus”, which may be connected through one or more adapters to one or more expansion buses, such as a form of Peripheral Component Interconnect (PCI) bus, HyperTransport or industry standard architecture (ISA) bus, small computer system interface (SCSI) bus, universal serial bus (USB), or Institute of Electrical and Electronics Engineers (IEEE) standard 1394 bus (sometimes referred to as “Firewire”).

The memory 320 may be or include one or more memory devices of one or more types, such as read-only memory (ROM), random access memory (RAM), flash memory, disk drives, etc. The network adapter 340 is a device suitable for enabling the processing system 301 to communicate data with a remote processing system over a communication link, and may be, for example, a conventional telephone modem, a wireless modem, a Digital Subscriber Line (DSL) modem, a cable modem, a radio transceiver, a satellite transceiver, an Ethernet adapter, or the like. The I/O devices 370, 380 may include, for example, one or more devices such as: a pointing device such as a mouse, trackball, joystick, touchpad, or the like; a keyboard; a microphone with speech recognition interface; audio speakers; a display device; etc. Note, however, that such I/O devices may be unnecessary in a system that operates exclusively as a server and provides no direct user interface, as is the case with the server in at least some embodiments. Other variations upon the illustrated set of components can be implemented in a manner consistent with the invention.

Software and/or firmware 330 to program the processor(s) 310 to carry out actions described above may be stored in memory 320. In certain embodiments, such software or firmware may be initially provided to the computer system 301 by downloading it from a remote system through the computer system 301 (e.g., via network adapter 340).

The techniques introduced above can be implemented by, for example, programmable circuitry (e.g., one or more microprocessors) programmed with software and/or firmware, or entirely in special-purpose hardwired circuitry, or in a combination of such forms. Special-purpose hardwired circuitry may be in the form of, for example, one or more application-specific integrated circuits (ASICs), programmable logic devices (PLDs), field-programmable gate arrays (FPGAs), etc.

Software or firmware for use in implementing the techniques introduced here may be stored on a machine-readable storage medium and may be executed by one or more general-purpose or special-purpose programmable microprocessors. A “machine-readable storage medium”, as the term is used herein, includes any mechanism that can store information in a form accessible by a machine (a machine may be, for example, a computer, network device, cellular phone, personal digital assistant (PDA), manufacturing tool, any device with one or more processors, etc.). For example, a machine-accessible storage medium includes recordable/non-recordable media (e.g., read-only memory (ROM); random access memory (RAM); magnetic disk storage media; optical storage media; flash memory devices; etc.), etc.

The term “logic”, as used herein, can include, for example, programmable circuitry programmed with specific software and/or firmware, special-purpose hardwired circuitry, or a combination thereof.

In addition to the above mentioned examples, various other modifications and alterations of the invention may be made without departing from the invention. Accordingly, the above disclosure is not to be considered as limiting and the appended claims are to be interpreted as encompassing the true spirit and the entire scope of the invention.

What is claimed is:

1. A credential free, alert based method for managing personal finances, the method comprising:
receiving from a financial institution a transaction message that is response to, and indicative of, occurrence of a financial transaction involving a user;
recognizing the transaction message and, in response thereto, generating an alert in a predetermined uniform format;
transmitting the alert to a device associated with the user, the alert for prompting a user to tag the transaction with at least one category; and
receiving from the user's device a response indicating a category that the user tagged.

2. The method of claim 1, further comprising:
transmitting to the user's device a personal finance summary.

3. The method of claim 1, wherein the transaction message does not contain any credential information.

4. The method of claim 1, wherein the transaction message is an email message.

5. The method of claim 1, wherein the alert is an SMS message or an email message.

6. The method of claim 1, wherein the alert is transmitted in near real-time or a short time period after the transaction has occurred.

7. The method of claim 1, wherein the device associated with the user is a mobile phone.

8. The method of claim 1, further comprising:
recording the response indicating the category that the user tagged into a database.

9. The method of claim 1, wherein recognizing the transaction message comprises recognizing the transaction message by using an intelligent parsing algorithm.

10. The method of claim 1, further comprising:
causing the device associated with the user to provide a default choice when prompting a user to tag the transaction with at least one category, wherein the default choice is based on categories of past transactions.

11. The method of claim 1, further comprising:
automatically tagging the transaction based on user-specified categories of past transactions.

12. The method of claim 1, further comprising:
generating a file containing a personal finance summary.

13. The method of claim 1, wherein the alert in the predetermined uniform format comprises a time stamp, a transaction amount, and a merchant ID.

14. A credential free, alert based personal finance management system, the system comprising:
a database;
a message receiving module to receive from a financial institution a transaction message that is response to, and indicative of, occurrence of a financial transaction involving a user;
a processing module to recognize the transaction message and, in response thereto, generate an alert in a predetermined uniform format;
a transmission module to transmit the alert to a device associated with the user, the alert for prompting a user to tag the transaction with at least one category; and
a recording module to receive from the user's device a response indicating a category that the user tagged and record the response into the database.

15. The system of claim 14, wherein the transmission module is further configured to transmit to the user's device a personal finance summary.

16. The system of claim 14, wherein the transaction message does not contain any credential information.

17. The system of claim 14, wherein the transaction message is an email message.

18. The system of claim 14, wherein the alert is an SMS message or an email message.

19. The system of claim 14, wherein the alert is transmitted near real-time or a short time period after the transaction occurring.

20. The system of claim 14, wherein the user's device is a mobile phone.

21. The system of claim 14, wherein the processing module recognizes the transaction message using an intelligent parsing algorithm.

22. The system of claim 14, wherein the alert prompts the user to tag the transaction with a default category choice based on categories of past transactions.

23. The system of claim 14, wherein the processing module is further configured to automatically tag the transaction based on categories of past transactions.

24. The system of claim 14, wherein the processing module is further configured to generate a file containing a personal finance summary.

25. The system of claim 14, wherein the alert in the predetermined uniform format comprises a time stamp, a transaction amount, and a merchant ID.

26. The system of claim 14, wherein the transaction message is received at an email address accessible by the system.

27. The system of claim 14, wherein the transaction message is received at an email address maintained by the system.

28. The system of claim 14, wherein the system is a standalone service system.

29. The system of claim 14, wherein the system is a add-on service of a financial institution.

30. The system of claim 14, wherein the financial institution is a bank, a credit union, a credit card company, a loan company or other organization providing financial information to the user.
